(19) United States
(12) Patent Application Publication
(10) Pub. No.: US 2014/0240340 A1
(43) Pub. Date: Aug. 28, 2014

(54) COLOR PROFILE GENERATING APPARATUS, IMAGE PROCESSING APPARATUS, IMAGE PROCESSING SYSTEM, METHOD OF GENERATING COLOR PROFILE, AND RECORDING MEDIUM STORING A PROGRAM FOR GENERATING COLOR PROFILE

(71) Applicant: Hisao SHIRASAWA, Kanagawa (JP)

(72) Inventor: Hisao SHIRASAWA, Kanagawa (JP)

(73) Assignee: RICOH COMPANY, LTD., Tokyo (JP)

(21) Appl. No.: 14/177,254

(22) Filed: Feb. 11, 2014

(30) Foreign Application Priority Data
Feb. 25, 2013 (JP) 2013-034871

(51) Int. Cl. H04N 1/60; H04N 1/00; G09G 5/02

(52) U.S. Cl. CPC H04N 1/6058; G09G 5/02; H04N 1/00129
USPC 345/590

(57) ABSTRACT

A color profile generator that generates a color profile to translate colors includes a data reading unit that reads image data of a specified image, a specification acceptance unit that accepts specifying an image type and an output device that outputs the image data, a screen display unit that displays a screen for inputting one or more setting values representing at least one index associated with the specified image type and emphasized in performing color translation, a parameter determination unit that determines a parameter used for translating colors based on the input setting value, and a profile generator that translates colors of the specified image based on the determined parameter and characteristic data regarding colors of the specified output device and generates the color profile using the read image data and a result of translating colors.

### CROSS-REFERENCE TO RELATED APPLICATION

This patent application is based on and claims priority pursuant to 35 U.S.C. §119 to Japanese Patent Application No. 2013-034871, filed on Feb. 25, 2013 in the Japan Patent Office, the entire disclosure of which is hereby incorporated by reference herein.

### BACKGROUND

1. Technical Field

The present invention relates to a color profile generating apparatus, image processing apparatus, image processing system, method of generating a color profile, and recording medium storing a program for generating a color profile.

2. Background Art

To print RGB data in correct colors using a printer, a color conversion process called color gamut mapping that maps the RGB data onto colors reproducible by the printer is indispensable. In color gamut mapping, a set of data called a color profile defines mapping between input color space and output color space of a device. An example of a color profile is an ICC profile that complies with a standard promulgated by the International Color Consortium (ICC).

In color gamut mapping, multiple translation tables provided in the ICC profile are selectively used based on the target colors to be reproduced (color reproduction target). Examples of the multiple translation tables are translation tables for multiple targets such as gradation-oriented (perceptual), chroma-oriented (saturation), and colorimetry-oriented (colorimetric). For example, if gradation-oriented color gamut mapping is required, color gamut mapping is performed using a perceptual translation table.

However, in some cases, in using the prepared fixed translation tables as described above, gradation collapses depending on characteristic of input image data and the reproduced colors lacks vividness. For example, if an input image consists of many more colors than the colors that are reproducible by a printer; several closely related colors are translated, or collapsed, into the same color. This translation is called gradation collapse. In addition, because the printer compresses in parallel until the color area reproducible by the printer is obtained, brightness remains unchanged but vividness deteriorates.

To cope with the problem described above, a technique that determines compression coefficient included in a color translation function based on a ratio between multiple color reproduction targets configured and converts image signals based on the color translation function that includes the compression coefficient has been proposed (e.g., JP-2007-325193-A). It is generally difficult to configure parameters and determine the compression coefficient by predicting color reproduction result to a certain degree. Consequently, a high degree of expertise is usually needed to create a profile that achieves the intended color reproduction target.

### SUMMARY

An example embodiment of the present invention provides a color profile generator that generates a color profile to translate colors. The color profile generator includes a data reading unit that reads image data of a specified image, a specification acceptance unit that accepts specifying an image type and an output device that output the image data, a screen display unit that displays a screen for inputting a setting value of at least one index associated with the specified image type and emphasized in performing color translation, a parameter determination unit that determines a parameter used for translating colors based on the input setting value, and a profile generator that translates colors of the specified image based on the determined parameter and characteristic data regarding colors of the specified output device and generates the color profile using the read image data and a result of translating colors.

An example embodiment of the present invention include a method of generating a color profile for translating colors, and a computer-readable, non-transitory recording medium storing a program that causes the computer to implement the method of generating a color profile for translating colors.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a block diagram illustrating an image processing system as an embodiment of the present invention.

FIG. 2 is a block diagram illustrating a color profile generator included in an image processing apparatus as an embodiment of the present invention.

FIG. 3 is a flowchart illustrating a process executed by the color profile generator as an embodiment of the present invention.

FIG. 4 is a diagram illustrating a screen displayed on a display unit as an embodiment of the present invention.

FIG. 5 is a flowchart illustrating a process of mapping color gamut as an embodiment of the present invention.

FIG. 6 is a conceptual diagram illustrating a process of compressing dynamic range as an embodiment of the present invention.

FIG. 7 is a conceptual diagram illustrating a process of mapping color gamut as an embodiment of the present invention.

FIG. 8 is a diagram illustrating a screen displayed to configure color reproduction policy in case of selecting a photo image in the configuration screen shown in FIG. 4 as an embodiment of the present invention.

FIG. 9 is a diagram illustrating relationship between configuration of color reproduction policy and characteristic of reproducing dynamic range as an embodiment of the present invention.

FIG. 10 is a diagram illustrating a screen displayed to configure color reproduction policy in case of selecting a graphic image in the configuration screen shown in FIG. 4 as an embodiment of the present invention.

FIG. 11 is a diagram illustrating a method of compressing color outside of reproducible color gamut of the graphic image as an embodiment of the present invention.

FIG. 12 is a diagram illustrating a method of mapping color signals outside of reproducible color gamut as an embodiment of the present invention.

FIG. 13 is a diagram illustrating a screen displayed to configure color reproduction policy in case of selecting a text/line art image in the configuration screen shown in FIG. 4 as an embodiment of the present invention.

FIG. 14 is a flowchart illustrating another process executed by the color profile generator as an embodiment of the present invention.

FIGS. 15A and 15B are diagrams illustrating a method of compressing colors outside of reproducible color gamut evaluating colors of a target image as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the following embodiment, a color profile generating apparatus that can generate a color profile that achieves a target color reproduction without high expertise is provided.

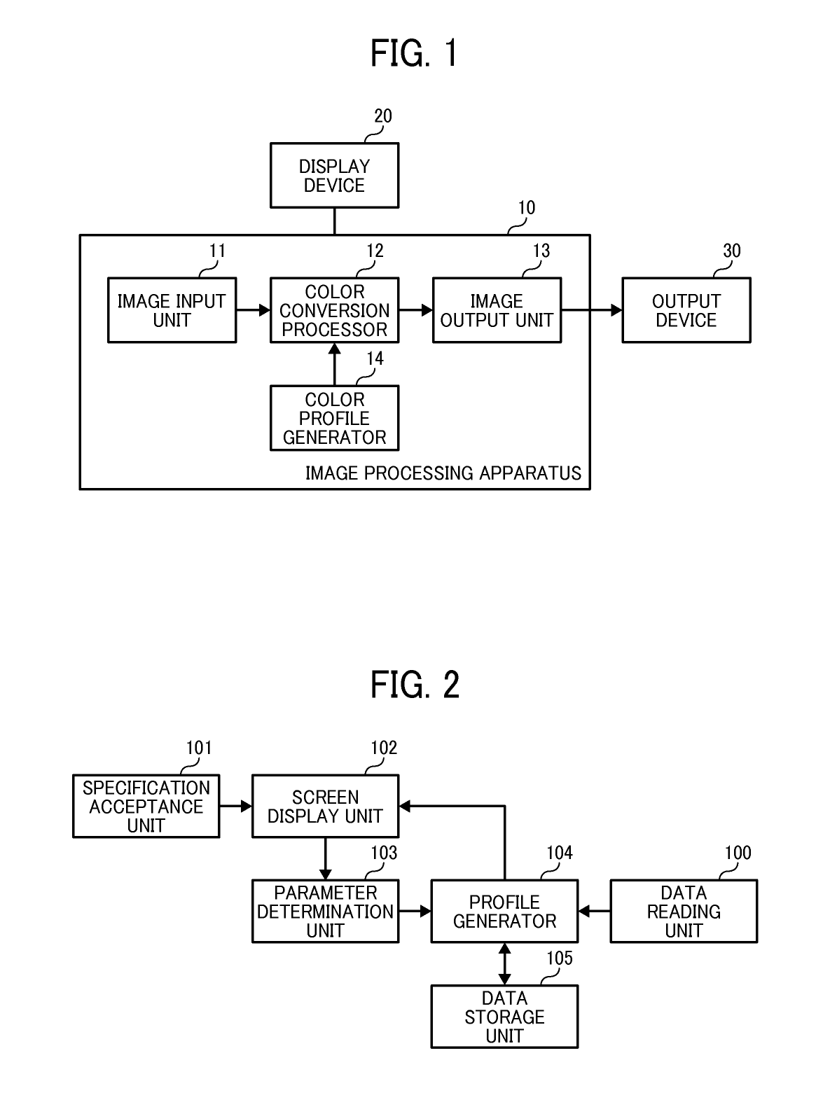

FIG. 1 is a block diagram illustrating an image processing system in this embodiment. The image processing system includes an image processing apparatus 10, a display unit 20, and an output device 30. The image processing apparatus 10, the display unit 20, and the output device 30 can be connected with each other via either cables or a network. In addition, the image processing apparatus 10, the display unit 20, and the output device 30 can be connected with each other using not only wired connection but also wireless technologies such as wireless LAN or Bluetooth.

As shown in FIG. 1, the image processing apparatus 10 includes an image input unit 11, a color translation processor 12, an image output unit 13, and a color profile generator 14. Here, the image input unit 11, the color translation processor 12, the image output unit 13, and the color profile generator 14 are illustrated as functional units. However, it is possible to configure them as an image input/output device, a color translation device, and a color profile generator, and the image processing apparatus 10 can include those devices.

The image input unit 11 accepts inputting image data from an input device (not shown in figures). The input devices, such as a scanner, a PC, and a multifunctional peripheral (MFP), can output image data. Examples of image data are color image data in an RGB color space to display on the display unit 20, color image data in CIELab color space, and color image data in CMYK color space. In the following description, the image data is the color image data in RGB color space.

The color translation processor 12 converts the image data accepted by the image input unit 11 into image data output by the image output unit 13 using an input profile and an output profile generated by the color profile generator 14. Here, two color profiles are used for the conversion. However, only one color profile can be used for the conversion.

The color translation processor 12 converts the color image data in RGB color space (RGB data) into color space independent from apparatuses such as CIE-L*a*b* color space. It can also be converted to CIE-XYZ color space independent from apparatuses.

RGB is a method of reproducing various colors by mixing the three primary colors, red (R), green (G), and blue (B). CMYK is a method of reproducing various colors by mixing four colors, cyan (C), magenta (M), yellow (Y), and black (K). CIE-L*a*b* color space was laid down by International Commission on Illumination (CIE) and describes colors with three coordinates, color brightness (L*), distance between red/magenta and green (a*), and distance between yellow and blue (b*). CIE-XYZ color space was also laid down by CIE and expresses colors with XYZ tristimulus values for color of an object by reflection.

Next, the color translation processor translates the image data translated into color space independent from apparatuses into color space dependent on the output device 30 such as CMYK color space. CMYK color space is just taken as an example, and other color space can be used for that purpose.

The image output unit 13 outputs the image data translated by the color translation processor 12 for the output device 30. If the output device 30 is a printer, image data in CMY color space and CMYK color space to be printed out by the printer can be taken as an example for the translated image data.

The color profile generator 14 displays a screen to configure parameters, accepts setting values input on the screen, and generates the color profile used by the color translation processor 12 using the setting values.

In the color profile, parameters that define relationship between device dependent data such as RGB data and CMYK data and device independent data such as Lab data and XYZ data are recorded. Regarding a color profile, ICC profile is known as standard format. To generate the color profile, a color translating process to correct difference between color reproducibility of input/output devices, that is, a process of mapping color gamut is necessary.

The image processing apparatus 10 includes a storage device that stores a program to implement a process executed by the functional units described above, a CPU that read and executes the program, and a connection interface to connect with the display unit 20 and the output device 30. Other than that, the image processing apparatus 10 can include a network interface to connect with a network and an input device to input data etc. A ROM, RAM, HDD, SSD, and flash memory can be taken as examples of the storage devices described above.

Examples of the display unit 20 are a CRT, liquid crystal display, plasma display, and organic EL display, and the display unit 20 displays a screen to configure parameters under the instruction from the color profile generator 14. In addition, the display unit 20 displays an image before translating colors and an image after translating colors.

Examples of the output device 30 are a printer, a MIT, and a PC, and the output device 30 outputs image data. The printer and the MFP print and output the image data. The PC displays the image data on a display unit included in the PC. In the case of the printer and MFP, the output device 30 includes a plotter that executes printing, a storage device that stores a program to control the plotter, a CPU that executes the program, and a connection interface to connect with the image processing apparatus 10. In the case of the PC, the output device 30 includes a CPU, storage device, and connection interface etc. just like the image processing apparatus 10.

The image processing apparatus 10 can be configured as being separated from the display unit 20 and the output device 30. Alternatively, the image processing apparatus 10 can be included in the output device 30, or the image processing apparatus 10 can include the display unit 20. Otherwise, the image processing apparatus 10 can be included in a server apparatus connected to the output device 30, or the image processing apparatus 10 can be included in a PC that instructs the output device 30.

FIG. 2 is a block diagram illustrating functional units included in the color profile generator 14. The color profile generator 14 functions as a color profile generating apparatus and includes a data reading unit 100, a specification acceptance unit 101, a screen display unit 102, a parameter determination unit 103, a profile generator 104, and a data storage unit 105.

After accepting instruction, the data reading unit 100 reads image data stored in the data storage unit 105 or another apparatus. The image data read by the data reading unit 100 is used for generating the color profile and can be any image data such as a person, landscape, graphic, text, computer graphics (CG), and logo etc. After one of the stored image data is selected, the data reading unit 100 can read the selected image data as specified image data.

While the specification acceptance unit 101 and the screen display unit 102 can be configured as user interface (UI) units, the specification acceptance unit 101 and the screen display unit 102 are described as separate functional units here. The specification acceptance unit 101 accepts image type and specified output device 30 that outputs the image data in accordance with user operation. Examples of image types are a photo image, graphic image, text/line art, logo, and CG etc. In the following description, the image types are limited to three types, photo image, graphic image, and text/line art.

The screen display unit 102 displays a screen to specify the image type and a screen to input a setting value of at least one parameter regarded as important in performing color translation associated with the image type accepted by the specification acceptance unit 101. That is, the image display unit 102 displays a screen to configure color reproduction policy for color profile different for each image type on the display unit 20.

The color reproduction policy is an index to reproduce colors. Examples of the color reproduction policy are contrast, gradation level of image (smoothness), color fidelity, and color identifiability etc. Contrast is difference in color and brightness. As contrast increases, it becomes possible to distinguish a noticed object from other background clearly. However, gradation becomes easy to collapse or bleed. Alternatively, as contrast gets low, it gets difficult to distinguish a noticed object from other background clearly. However, gradation becomes hard to collapse or bleed.

Smoothness is a measure of expressing fineness of color change. If smoothness gets fine, the color changes smoother. Contrast and smoothness are inversely related: If contrast is high, smoothness is lost. If contrast is low, smoothness improved.

Fidelity is an index of how faithfully color is reproduced compared to color displayed on the screen, and as fidelity increases, color gets more similar to color displayed on the screen. Identifiability is an index of how much colors can be identified, and as identifiability increases, it becomes possible to distinguish the color clearly. While only four indexes are described here, the color reproduction policy can include other indexes.

The parameter determination unit 103 determines a parameter that controls mapping color gamut and is used for translating colors based on setting values of indexes input on the screen displayed on the display unit 20. The parameter will be described in detail later. The profile generator 104 translates colors on the image based on the parameter determined by the parameter determination unit 103 and the characteristic data regarding colors on the output device 30 stored in the data storage unit 105. Subsequently, the profile generator 104 generates the color profile using the read original image data and the result of translating colors, i.e., image data after translating colors. The color profile is generated so that it includes a color translation table.

By the color translation, the profile generator 104 translates input RGB data into Lab data and Lab data into CMYK data. Concurrently, the profile generator 104 calculates Lab value and CMYK value. Subsequently, the profile generator 104 generates the color translation table using the calculated values. After generating the color translation table, the profile generator 104 instructs the screen display unit 102 to display the color translation result on the screen.

The data storage unit 105 stores the characteristic data regarding colors on the output device 30. After the color profile generator 14 communicates with the output device 30, the characteristic data can be acquired from the output device 30 and stored in the data storage unit 105. In addition, the characteristic data can be stored in the data storage unit 105 via a storage device such as a USB memory.

The characteristic data is data regarding characteristics of functions and ink etc. included in the output device 30. An example of the characteristic data for colors is data of color reproducible area as color gamut reproducible by the output device 30. If the output device 30 is the printer and MFP, the characteristic data includes ink characteristic such as ink chromaticity value and gamma characteristic of used ink.

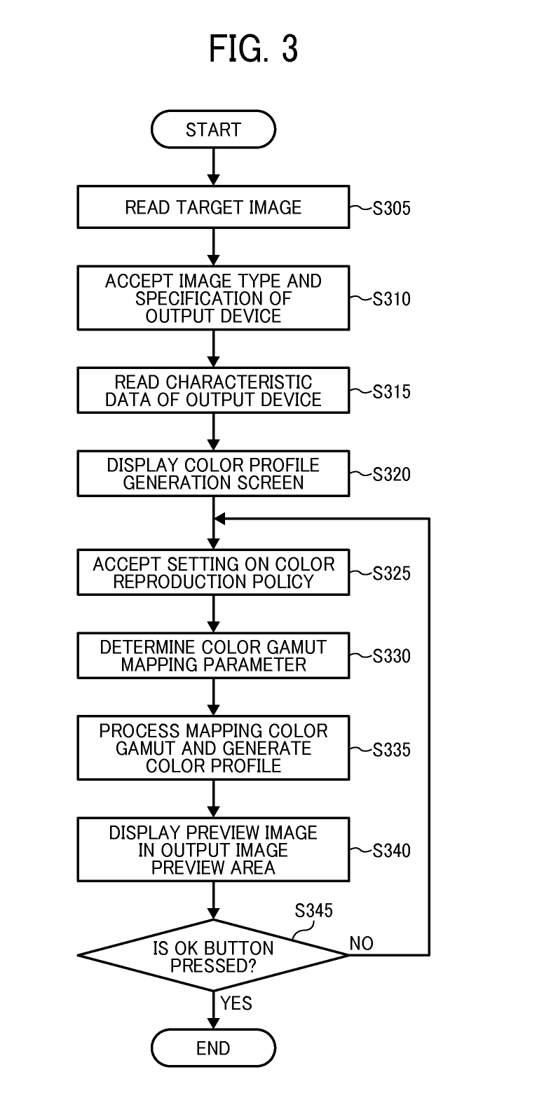

A process executed by the color profile generator 14 is described in detail below with reference to FIG. 3. After starting the process, a selected image to check color translation result using the generated color profile is read in S305. Examples of the selected image are a person, landscape, graphic, and text etc. as described above. The image can be stored in the storage unit included in the image processing apparatus 10 or acquired from the input device etc. by the image input unit 11.

In S310, the specified image type and the output device 30 input by the user are accepted. Examples of the image types are a photo image, graphic image, text/line art etc. as described above. Examples of the output device 30 can be a printer, a MFP, and a virtual printer. Here, the virtual printer is a model that the color reproducibility of the printer is virtually defined on device independent color space.

In S315, the characteristic data that corresponds with the specified output device 30 is read from the data storage unit 105. Examples of the read data are the color reproducibility data described above and ink characteristic etc. If the output device 30 is the virtual printer, the color reproducibility data of the virtual device defined on the device independent color space and virtual ink characteristic are read similarly.

If there is no color reproducibility data, the color reproducibility can be calculated by reading ICC color profile that corresponds with the output device 30. In addition, if the output device 30 is the printer, the color reproducibility can be calculated by outputting a predetermined patch and measuring its color.

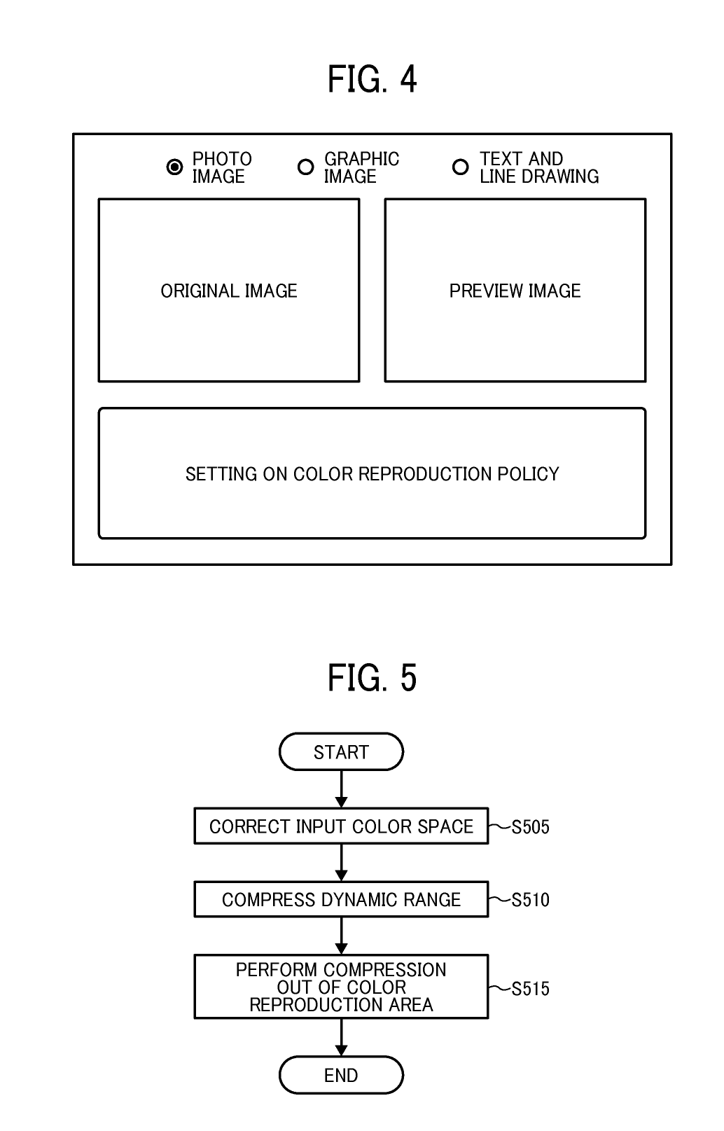

In S320, a screen to generate a color profile associated with the specified image type is displayed on the display unit 20. Here, the displayed screen is described with reference to FIG. 4. The screen includes multiple radio buttons to select an image type, windows to display a preview of an original image and a preview image of an output image, and a screen to configure the color reproduction policy.

For example, if the photo image is selected for the image type, a black circle is displayed in the radio button next to the photo image, and that shows that the photo image is selected. A read image is displayed in the window for the original image, and a preview image that simulates a reproducing result by the output device 30 is displayed in the window for previewing an output image. While the screen to configure color reproduction policy will be described in detail later, the user configures the color reproduction policy, and that results in generating a color profile that realizes intended image quality. Therefore, intuitive expression for image quality such as smoothness is used for the color reproduction policy.

Again, with reference to FIG. 3, in S325, the setting value for the color reproduction policy input on the screen to configure the color reproduction policy displayed on the display unit 20 is accepted. In S330, a color gamut mapping parameter used for translating colors is determined based on the setting value.

In S335, the color translation is performed on the specified image, i.e., the color gamut mapping process is performed on the specified image with reference to the determined color gamut mapping parameter and the characteristic data of the output device 30 stored in the data storage unit 105. Subsequently, the color profile is generated by calculating output Lab value or CMYK value that corresponds with the input image data (RGB data) and generating the color translation table.

The color translation table is used for translating the input RGB data into L*a*b* value or CMYK value of the printer as the output device 30. For example, the color translation table can consist of a three-dimensional lookup table (3D-LUT) or a tone reproduction curve (TRC) etc. It is not limited to the color translation table, and a color translation function etc. can be used for that purpose.

The input RGB data can be sRGB data as a color space specification laid down by International Electrotechnical Commission (IEC) or AdobeRGB data laid down by Adobe Systems, Inc. If L*a*b* value of the printer corresponding to the input RGB data is used as the color translation table, it is formatted as the input profile. If CMYK value corresponding to the input RGB data is used as the color translation table, it is formatted in standard ICC profile as a device link profile.

In S340, an image of simulating printing is generated using the generated color profile, and the generated preview image is displayed in the window for previewing the output image. It is determined whether or not the image quality is intentional by comparing the original image with the preview image. In S345, it is accepted whether or not the image quality is OK. If it is OK, the process ends. Alternatively, if it is not OK, the process goes back to S325, and the setting value is accepted.

The color profile generator 14 displays the screen to configure not all color reproduction policy but only appropriate color reproduction policy in accordance with the image type and displays the preview image immediately after inputting the setting value. Consequently, it is possible to generate the color profile that realizes the intended color reproduction easily in accordance with the characteristic of the target on which the color translation is performed without high expertise.

Relationship between the color reproduction policy configured in S325 and the color gamut mapping parameter determined in S330 is described below in detail.

First, a process for mapping color gamut performed based on the color gamut mapping parameter is described. FIG. 5 is a flowchart illustrating the process of mapping color gamut. After starting the process, in S505, in mapping color space of the input image (input image color space) onto color space reproducible by the output device 30, the input image color space is corrected.

The correcting process is mainly performed on colors within color gamut of the output device 30 (color reproducible area), and hue, chroma, and brightness in the input color space are corrected. This correction can be performed along with user preference. For example, this correction can be performed in order to reproduce emphasizing a notable object. After dividing the input color space into multiple color hue areas, the correcting process can be performed for each of divided color hue areas using chroma correction parameter and brightness correction parameter, etc., as color gamut mapping parameters. This correcting process can be performed not only in color space independent from device such as L*a*b* color space but also in HSL color space etc. convertible linearly from the RGB data. HSL color space consists of three components, hue, chroma, and brightness.

In S510, a process for correcting dynamic range (process for compressing dynamic range) is performed in order to correct difference in dynamic range between the input color space and the color space reproducible by the output device 30 (output color space). Generally, since the color reproducible area of CMYK color space of the output device 30 is narrower compared to RGB color space, the compression process is performed. The dynamic range is indicated as width from a black color point (BP) as the minimum value of data to a white color point (WP) as the maximum value of data.

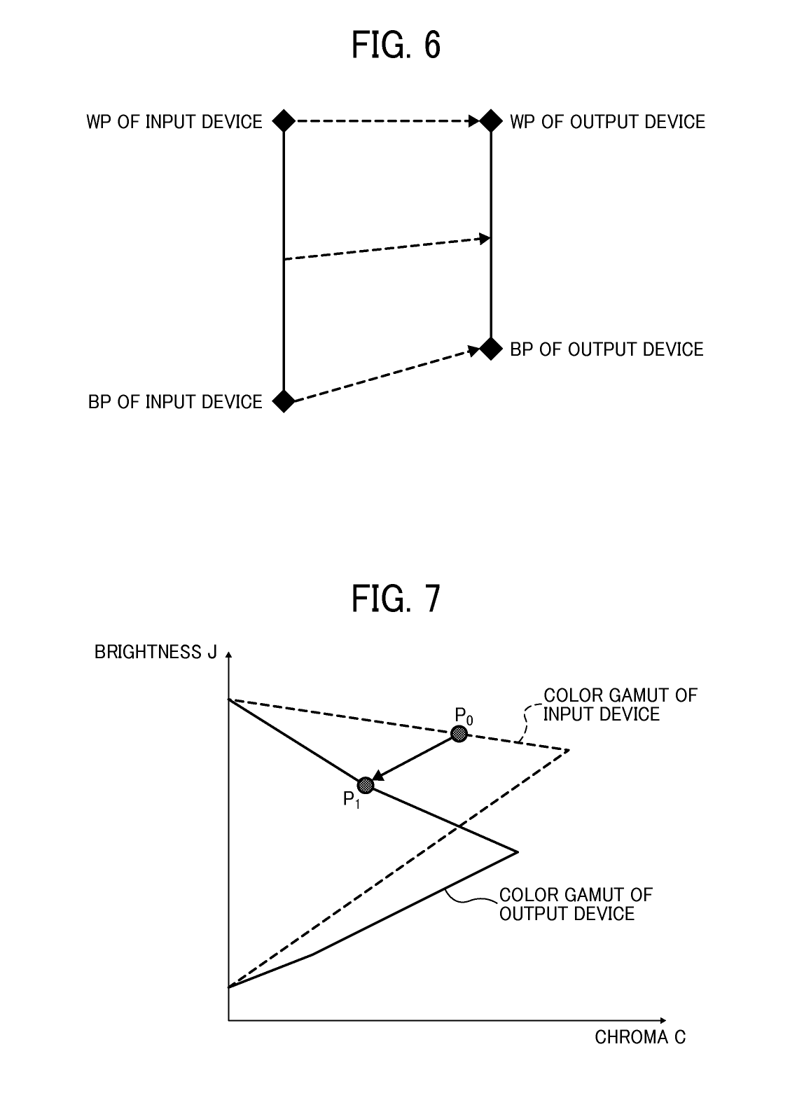

As shown in FIG. 6, in the process of compressing dynamic range, WP and BP of the input device is fit into WP and BP of the output device 30. Generally, assuming complete adaptation, WP of both the input device and the output device 30 are normalized to 100. The process of compressing dynamic range is performed using dynamic range correction parameter (dynamic range compression parameter) as color gamut mapping parameter.

In S505 and 5510, the process of compressing out of color reproducible area reproducible by the output device 30 is not performed. Consequently, at the time of finishing S510, color unreproducible by the output device 30 exists. In order to make this color reproducible, in S515, the process of compressing out of color reproducible area is performed for colors unreproducible by the output device 30, and those colors are translated into colors reproducible by the output device 30. Subsequently, the process ends. The process of compressing out of color reproducible area is performed using hue correction amount and color gamut mapping direction as color gamut mapping parameters.

FIG. 7 is a conceptual diagram illustrating a process of mapping color gamut. While color gamut of both the input device and the output device 30 are illustrated in three dimensions, in FIG. 7, they are simplified and illustrated in two dimensions. Broken lines illustrate color gamut of the input device (color reproducible area), and solid lines illustrate color gamut of the output device 30.

A color signal P₀ in the color reproducible area of the input device does not exist in the color reproducible area of the output device 30. Therefore, by mapping onto a reproducible color signal P₁, the color reproduction with feeling less uncomfortable as possible is performed. In compressing out of color reproducible area, reproducible colors in a part where the color gamut overlaps are not changed.

In processing mapping color gamut, there are many parameters since multiple kinds of process are performed as shown in FIG. 5. However, magnitude of the impact that the color gamut mapping parameters affect the color reproduction is uneven and differs depending on image types.

With reference to color distribution of input images, colors reproducible by the output device 30 are used frequently in the photo image, and high chroma colors unreproducible by the output device 30 tend to be used frequently in the graphic image. In addition, while some graphic images use only uniform solid colors (primary colors), other graphic images use lots of gradation that places greater emphasis on grading. In the case of text and line art, while grading has little or nothing relationship, visibility is emphasized since characters and lines need to be identified.

Consequently, in the case of the photo image, the image quality is hardly affected by adjusting parameters of compressing out of color reproducible area. On the other hand, in the case of the graphic image, the parameters of compressing out of color reproducible area tend to affect a lot.

In configuring all the color gamut mapping parameters that affect at different levels as described above on a same screen uniformly, a user without high expertise does not know how to configure parameters. To solve this issue, in an example of the present invention, the color gamut mapping is controlled by displaying configuration screens for color reproduction policy suitable to each image type.

Since color gamut mapping parameters shown in FIG. 5 are too specialized, it is difficult for the user without high expertise to operate those parameters on the screen for configuring color reproduction policy. Therefore, in an example of the present invention, parameters can be configured using factors that control the image quality intuitively for each image type. Consequently, profile can be generated using common configuration parameters even with the output device 30 that has different color reproduction characteristic.

A process of generating profile is described below in detail using a specific example. In this case, the process is performed after the user specifies the photo image and that is accepted. Since colors within color reproducible area are used frequently in the photo image, the color gamut mapping is controlled by indicating color reproduction policy within the color reproducible area in configuring the color reproduction policy.

Examples of the color gamut mapping processes that affect the color reproduction in the color reproducible area a lot are the input color space correction in 5505 and dynamic range compression in S510. Since parameters of compressing out of color reproducible area do not affect output image in most cases, those parameters are fixed and not displayed on the screen.

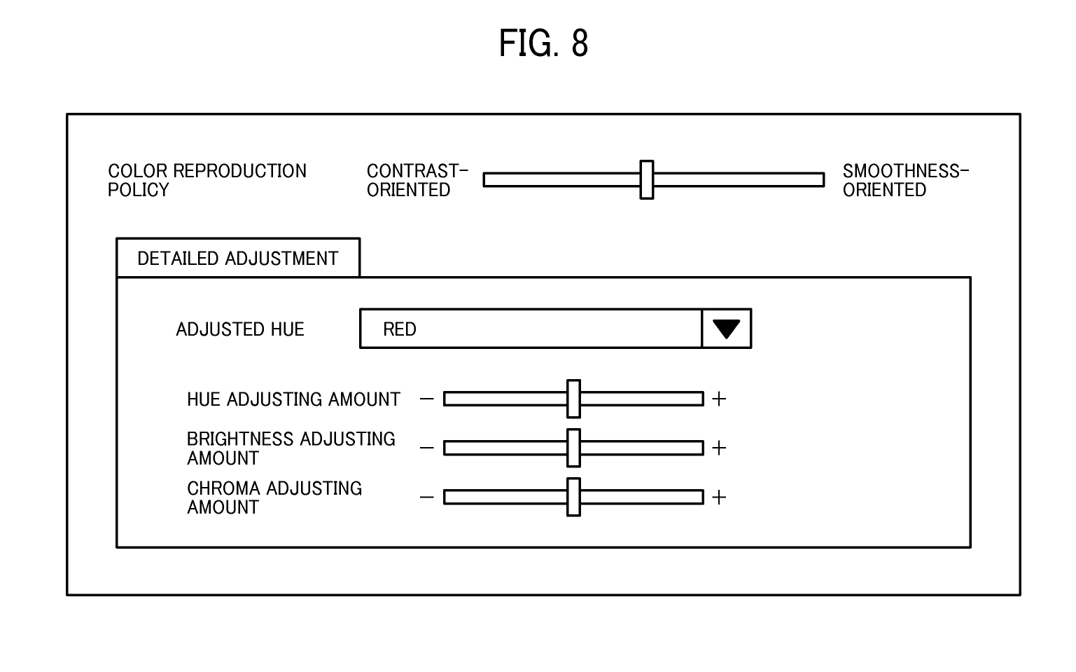

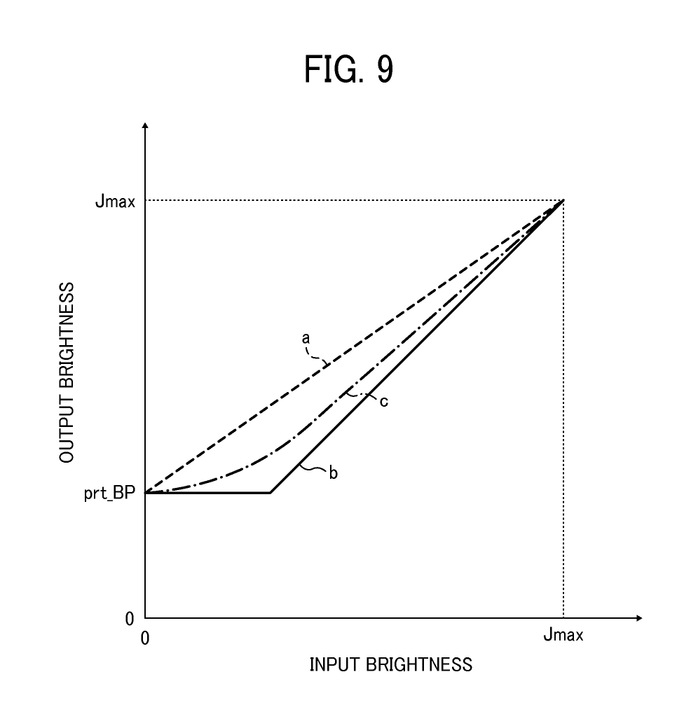

With reference to a screen for configuring color reproduction policy for the photo image shown in FIG. 8, operation on the screen is described in detail below. In the case of the photo image, impression on output result is preferable with high contrast in many cases. However, if contrast increases, gradations are easy to collapse. Consequently, two indexes, “contrast” and “smoothness” that indicates grading of the image, are displayed on the screen shown in FIG. 8 as color reproduction policy, and the color gamut mapping parameter is controlled by adjusting the balance between the two color reproduction policies. In FIG. 8, it is possible to adjust the balance using a slide bar, and indexes can be weighed as setting values by the position of the slide bar.

As described above, after specifying the image type as the photo image, since the two color reproduction policies selected in accordance with the specified type are displayed on the screen, the user does not need to configure all the color reproduction policies. In addition, since it is possible to adjust them only by sliding the slide bar, it is possible to configure them easily without high expertise. The example that uses the slide bar is shown here. However, it is not limited to that, and it also can be configured by setting inputtable value range and inputting values within the range.

It is possible to adjust only the balance between the two color reproduction policies. However, in the screen shown in FIG. 8, after selecting adjusted hue, brightness, chroma, and hue of reproduced color of the selected hue can be adjusted to perform adjustment in detail. The adjusted hue can be selected using a pull down menu, and “red” is selected in FIG. 8.

In the case of the selected hue “red”, hue, chroma, and brightness can be adjusted using the slide bar. Not only the hue “red” but also other colors can be adjusted by selecting the color using the pull down menu.

In configuring the color reproduction policies, contrast and smoothness in the direction of brightness and chroma are mainly reflected on chroma correction parameter of input color space correction in mapping color gamut and parameter of dynamic range compression. The chroma correction parameter is a parameter for correcting chroma in color space of the input image. The dynamic compression parameter is a parameter for correcting difference in dynamic range between color space of the input image and color space reproducible by the output device 30 acquired from specific data.

A method of reflecting on the chroma correction parameter of input color space correction is described below. One example is to correct by multiplying chroma in input color space at defined number using equation 1 shown below. In equation 1, C is chroma in the input color space, C′ is chroma in the output color space, and Re is chroma correction parameter.

C′=C×Re Equation 1

The larger chroma correction parameter Re means contrast-oriented, and the smaller chroma correction parameter Re means smoothness-oriented. Therefore, in accordance with the position of the slide bar of the color reproduction policy, predetermined values 0 if the slide bar is positioned at smoothness-oriented, 1 if the slide bar is positioned at center, and 2 if the slide bar is positioned at contrast-oriented can be configured, and that value can be used as Re. The determination of Re is not limited to that, and Re can also be determined in accordance with the color reproducible area of the output device 30. The methods described above are examples, and it is possible to adopt other methods.

Next, a method of reflecting the compression parameter is described below. FIG. 9 is a diagram illustrating relationship between configuration of color reproduction policy and characteristic of reproducing dynamic range. In FIG. 9, Jmax indicates the highest brightness reproducible by a device. In addition, prt_BP (printer black point) indicates the lowest brightness reproducible by the output device 30 and can be acquired from the characteristic data read in S315 in FIG. 3.

In FIG. 9, translation curve a is used for reproducing input/output brightness linearly so as not to collapse gradation. Translation curve b is used for performing contrast-oriented reproduction from halftone to highlight rather than a shadow part of the input image. In the case of an image with lots of shadows, it is preferable to select the translation curve a so that the gradation collapse is not highlighted. By contrast, in the case of an image with fewer shadows the dynamic range of the image can be extended by selecting the translation curve b, and it is possible to reproduce a more preferable image.

Consequently, if the color reproduction policy is contrast-oriented, it is configured to perform the color gamut mapping selecting the translation curve b, and if the color reproduction policy is smoothness-oriented, it is configured to perform the color gamut mapping selecting the translation curve a. If the color reproduction policy is adjusted by the slide bar and the value within the slide bar range is set, translation curve c shown in FIG. 9 is generated in accordance with the setting value, and the color gamut mapping can be performed using the generated translation curve c.

For example, the translation curve c can be generated by configuring contrast-oriented as 0 and smoothness-oriented as 100, calculating points between the translation curve a and the translation curve b, and connecting those points smoothly. This is an example, and other methods can be used for generating the translation curve c.

Chroma adjustment amount and brightness adjustment amount adjusted in detailed adjustment are used for further adjusting the chroma correction parameter. After adjusting contrast and smoothness using the slide bar, the chroma adjustment amount is adjusted if it is necessary to adjust only contrast of chroma. In addition, the brightness adjustment amount is adjusted if it is necessary to adjust only contrast of brightness. If it is necessary to adjust contrast both chroma and brightness, both adjustment amounts are adjusted.

In the case of the photo image, the color gamut mapping that corresponds to hue is performed by default. Therefore, it is unnecessary to adjust hue adjustment amount in detailed adjustment. However, in some cases, it is necessary to adjust hue for reproducing colors more preferably, and the hue adjustment amount can be adjusted in those cases.

After performing adjustment as described above, parameters used for translating colors are modified based on the setting values acquired by the adjustment, and those modified parameters are applied to the image data immediately. Since the image data to which the parameters are applied is displayed as a preview image, it is possible to perform the adjustment checking the adjustment result by browsing the preview image.

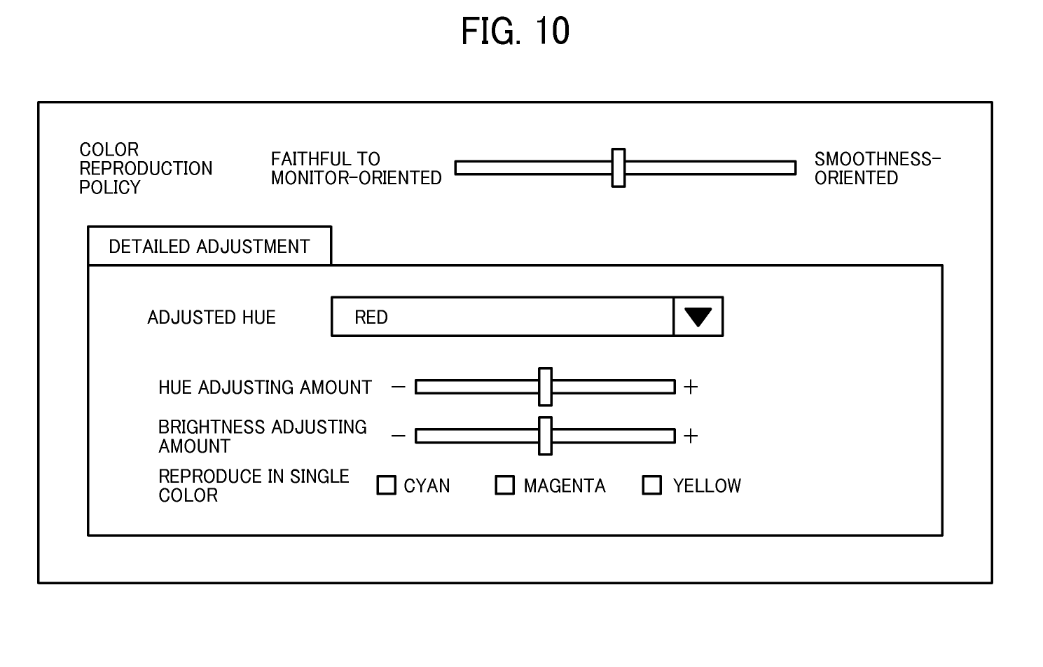

Next, with reference to a screen of configuring the color reproduction policy for the graphic image as shown in FIG. 10, operation on the screen is described in detail. In the graphic image, high chroma colors out of color reproducible area of the output device 30 are frequently used. Therefore, in configuring the color reproduction policy, the color gamut mapping is controlled by presenting the color reproduction policy out of the color reproducible area of the output device 30. An example of the color gamut mapping process that affects the color reproduction outside the color reproducible area a lot is compressing process outside the color reproducible area.

Among images called graphic images, there are various pictures such as brightness-oriented filled pattern like a graph and gradation reproducibility-oriented gradation, etc. In business-use figures, brightness and gradation reproducibility are emphasized. However, in the case of a design-oriented image, color faithfulness that reproduces colors faithfully is emphasized in many cases.

Consequently, two indexes “faithful to monitor” and “smoothness” are displayed as the color reproduction policies on the screen shown in FIG. 10, and the color gamut mapping parameter can be controlled by adjusting the balance between the two color reproduction policies. In FIG. 10, the balance can be adjusted using the slide bar, and the weighed indexes in accordance with the position of the slide bar can be configured as the setting value.

In the adjustment, correction that reflects the color reproduction policy is performed inside the color reproducible area at the same time of performing the color gamut mapping process outside the color reproducible area. Therefore, the color reproduction policy that corresponds to the input color translation correction in S505 and the dynamic range compression in 5510 shown in FIG. 5 are not configured.

In this case, assuming a case in which the detailed adjustment is necessary, a screen for adjusting in detail similar to FIG. 8 is provided. That is, the adjusting color is selected using the pull down menu, and brightness and hue of reproduced color of the selected color can be adjusted using the slide bar. Here, the adjusting color has different meaning from the adjusting hue shown in FIG. 8. While the adjusting hue means hue space, the adjusting color means the highest chroma color of the primary colors, R, G; B, C, M, and Y. The primary colors are not limited to the six colors, and it is possible to add the highest chroma colors of their half hue and use more than six colors for that purpose.

In the graphic image, a single color compensation that reproduce input colors such as C, M, and Y using single color of the output device 30 to prevent ink from bleeding is emphasized in many cases. In consideration of that point, a check box for toggling the single color compensation between on and off is displayed on the screen in FIG. 10.

The setting values configured on the screen shown in FIG. 10 are reflected on the color gamut mapping parameters outside the color reproducible area. The mapping process outside the color reproducible area is generally performed in following three steps. (1) Corresponding color M that corresponds to primary color Ti is determined. (2) Input hue is corrected in accordance with the corresponding color M. (3) The input color signal is mapped onto colors inside the color gamut of the output device 30.

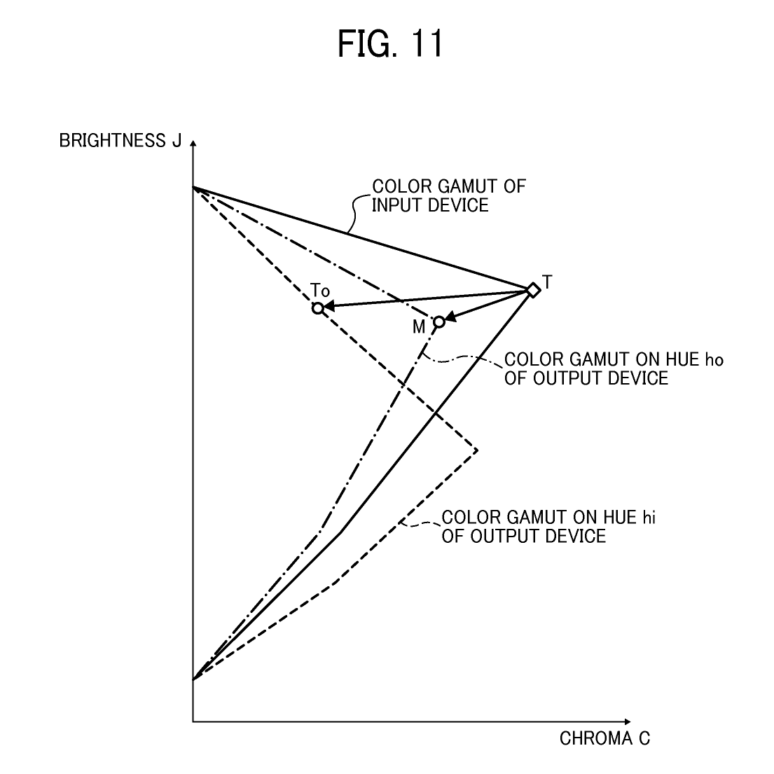

A method of compressing colors outside the color reproducible area is described in detail below with reference to FIG. 11. FIG. 11 is a diagram illustrating relationship between the color reproducible area of the input device and the color reproducible area of the output device 30. In FIG. 11, the color gamut of the input image from the input device and two color gamut of the output device 30 are illustrated. One is color gamut of the output device 30 whose hue hi is the same as primary color T and the other is color gamut of hue ho that includes corresponding color M whose hue is different and color difference becomes minimum.

First, the corresponding color that corresponds to the primary color T is determined. In the case of faithful to monitor-oriented, the corresponding color is M as the minimum point of the color difference. That is, its distance from T is the shortest, and it is the nearest point from T. Since the corresponding color M is not located on hue hi the same as the primary color T, hue of the corresponding color M is different from hue of the primary color T. In the case of smoothness-oriented, the corresponding color is determined as color that maintains brightness on the same hue hi. In FIG. 11, the corresponding color To that maintains brightness on the same hue hi is determined. Regarding parts where color gamut overlaps, colors are not changed in the case of faithful to monitor-oriented. In the case of smoothness-oriented, since it is necessary to change colors, the corresponding color is determined from T to To in the color gamut mapping direction in accordance with brightness and chroma.

If the color reproduction policy is set between faithful to monitor-oriented and smoothness-oriented by the adjustment, the corresponding color is set to hue between M and To in accordance with the ratio of the color reproduction policy. The balance of the color reproduction policy can also be adjusted by the slide bar, and the weighed indexes can also be configured as a setting value in accordance with the position of the slide bar.

The result of the adjustment is displayed as the preview image immediately. After checking the displayed image, adjustment is performed by moving the slide bar or the color reproduction policy if further adjustment is necessary. The adjustment can also be performed by adjusting hue adjustment amount and brightness adjustment amount.

In addition, if the check box of single color reproduction is checked, the corresponding colors that correspond to C, M, and Y are adjusted so that they correspond with colors of C. M, and Y of the output device 30 forcibly.

Next, hue of the input image is corrected in accordance with the corresponding color of the primary color T. If correction Δh (Ti) is performed on hue of the primary color Ti, hue of color within the color reproducible area on the same hue hi as Ti is shifted Δh (Ti) similarly in the case of gradation-oriented. Otherwise, in the case of faithful to monitor-oriented, colors within the color reproducible area are not corrected. That is, regarding colors in an area where color gamut of the input device overlaps with color gamut on hue hi of the output device 30, hue correction is not performed.

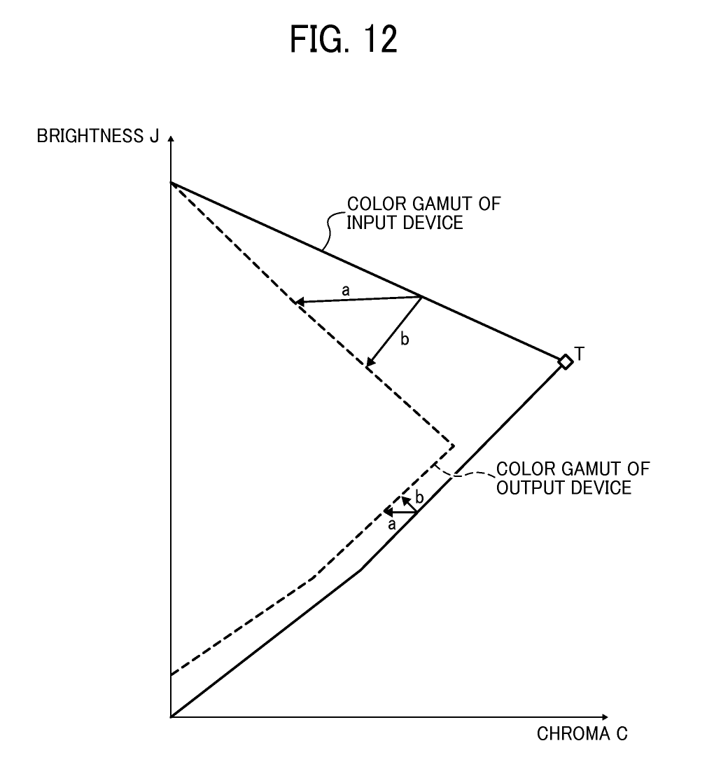

Lastly, the input color signal corrected hue is mapped onto colors within color gamut of the output device 30. Examples of methods of mapping the input color signal Pi are a mapping method maintaining brightness such as vector a in FIG. 12 and a mapping method brightness-oriented such as vector b in FIG. 12. The mapping method maps brightness-oriented maps onto the color whose distance is the shortest.

Generally, chroma vector b is higher than vector a, and vector b is preferable for images such as graph in many cases. However, gradation tends to be collapsed by vector b. Consequently, two indexes, “faithful to monitor” and “smoothness”, are displayed selectively on the screen shown in FIG. 10, and direction of the color gamut mapping is configured in accordance their weight. The direction of the color gamut mapping is indicated by arrows such as vector a and b.

For example, in the case of faithful to monitor-oriented, vector b becomes the compressing direction, and in the case of smoothness-oriented, vector a becomes the compressing direction. If the slide bar of the color reproduction policy is adjusted between them, direction in angle between vector a and b in accordance with their ratio becomes the compressing direction.

Therefore, based on the setting value configured using the slide bar, hue correction amount or color gamut mapping direction can be determined as color gamut mapping parameter. The hue correction amount is correction amount to correct hue outside color gamut reproducible by the output device 30 acquired from the characteristic data among color gamut of the input image. The color gamut mapping direction is the mapping direction that maps hue outside the color reproducible area onto hue within the area reproducible by the output device 30. By providing the screen described above, it is possible to generate a color profile for the graphic image whose gradation and faithfulness are well-balanced by only configuring the uncomplicated color reproduction policy.

The method of mapping color gamut outside the color reproduction policy has been proposed (e.g., JP-2002-262120-A and JP-2008-011293-A).

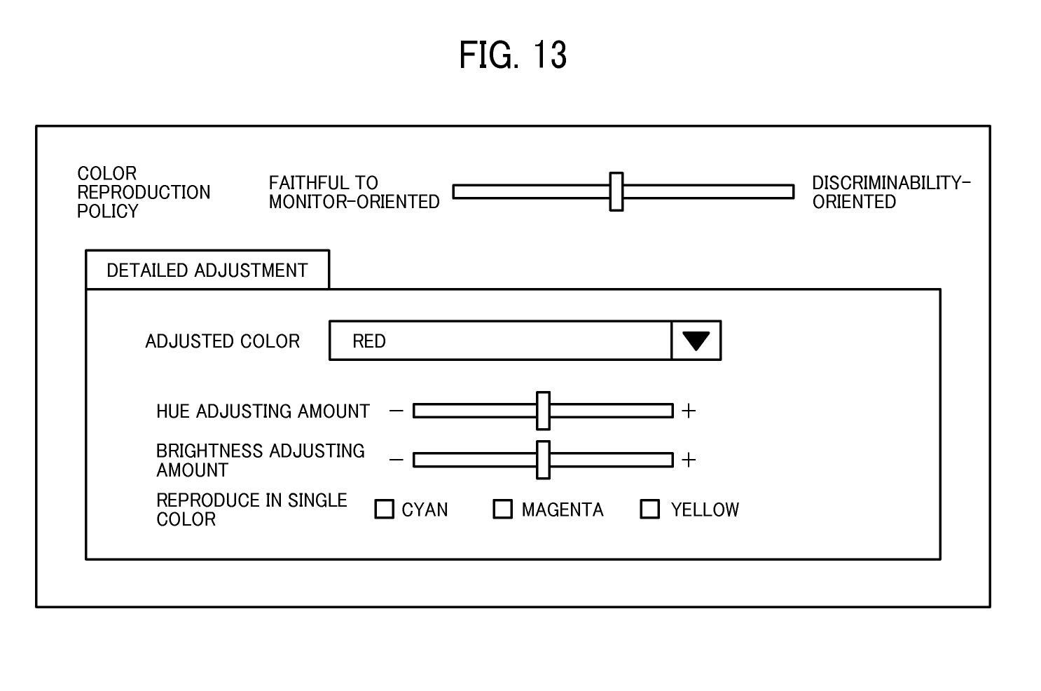

Next, with reference to a screen of configuring the color reproduction policy for the text and line art as shown in FIG. 13, operation on the screen is described in detail. In the text and line art, similar to the graphic image, high chroma colors out of color reproducible area of the printer as the output device 30 are frequently used. Therefore, in configuring the color reproduction policy, the color gamut mapping is controlled by presenting the color reproduction policy outside the color reproducible area.

Most of text and line art are monochrome. Therefore, gradation is not placed much value in many cases. In addition, since text and line art are drawn in using lines, their colors tend to be difficult to identify. Consequently, in reproducing colors, visibility and identification of characters are placed much value in many cases. Furthermore, in text and line art, similar to the graphic image, reproduction by single color ink C, M, Y, and K is required prevent ink from bleeding is emphasized in many cases.

Consequently, two indexes, “faithful to monitor” and “identifiability”, are displayed on the screen shown in FIG. 13 as color reproduction policy, and the color gamut mapping parameter is controlled by adjusting the balance between the two color reproduction policies. Likewise, in FIG. 13, it is possible to adjust the balance using the slide bar, and indexes can be weighed as setting values by the position of the slide bar.

In the adjustment, correction that reflects the color reproduction policy is performed inside the color reproducible area at the same time of performing the color gamut mapping process outside the color reproducible area. Therefore, the color reproduction policy that corresponds to the input color translation correction and the dynamic range compression are not configured.

Similarly, in this case, assuming a case in which the detailed adjustment is necessary, a screen for adjusting in detail similar to FIG. 10 is provided. That is, the adjusting color is selected using the pull down menu, and brightness and hue of reproduced color of the selected color can be adjusted using the slide bar.

In text and line art, similar to the graphic image, a single color compensation that reproduce input colors such as C, M, and Y using single color of the output device 30 to prevent ink from bleeding is emphasized in many cases. In consideration of that point, a check box for toggling the single color compensation between on and off is also displayed on the screen in FIG. 13.

Generally, if characters whose color is black or blue etc. with low brightness are reproduced on background with low brightness, it is difficult to distinguish those characters from the background, and that results in deteriorating visibility. By contrast, if characters whose color is yellow or cyan etc. with high brightness are reproduced on background with high brightness such as white, it is difficult to distinguish those characters from the background, and that results in deteriorating visibility. Consequently, in the case of identifiability-oriented, text and line art are output with high chroma color as possible, and it is possible to distinguish colors even with thin lines. By contrast, in the case of faithful to monitor-oriented, compression outside the color reproducible area is performed so that visual colors correspond as possible.

In this case, only the process of compressing outside the color reproducible area is performed too, and it is performed in three steps just like the case of the graphic image. First, corresponding color M that corresponds to primary color Ti is determined. In the case of faithful to monitor-oriented, the corresponding color is M as the minimum point of the color difference just like the case of the graphic image. In the case of identifiability-oriented, the corresponding color is determined as color that maintains chroma on the same hue. In the case of the graphic image, the corresponding color is color that maintains brightness. However, in the case of text and line art, the corresponding color is color that maintains chroma in order to output with high chroma as possible.

If the slide bar of the color reproduction policy is positioned between faithful to monitor-oriented and identifiability-oriented, the corresponding color is configured as hue between M and To in accordance with the ratio of faithful to monitor-oriented to identifiability-oriented. The result of the adjustment is displayed as the output preview image. After checking the displayed image, adjustment is performed by moving the slide bar or the color reproduction policy if further adjustment is necessary. The adjustment can also be performed by adjusting hue adjustment amount and brightness adjustment amount in the detailed adjustment.

Next, input hue correction is performed in accordance with the corresponding color M. In the case of faithful to monitor-oriented, input color within the color reproducible area is not corrected just like the graphic image. In the case of identifiability-oriented, hue of the input image is corrected to hue of the corresponding color.

Lastly, the input color signal is mapped onto colors within color gamut of the output device 30. In the case of faithful to monitor-oriented, input color signal is mapped on a point where color difference becomes minimum in the same hue. In the case of identifiability-oriented, after correcting brightness and chroma of input color space in accordance with the corresponding color so that the difference of brightness of color of characters becomes larger than a predetermined value, color gamut mapping is performed with maintaining brightness. In the case of identifiability-oriented, it is preferable to make the difference of brightness between background color and output color large.

After adjusting the balance using the slide bar, weighed indexes are input as the setting values depending on the position of the slide bar. Based on the input setting values, the color profile generator 14 determines which parameter to use. For example, in case of specifying the photo image and setting contrast-oriented, it is determined to use chroma correction parameter and dynamic range compression parameter that uses the translation curve b shown in FIG. 9. The color gamut mapping is performed based on the determined parameter and the characteristic data, and the color profile is generated by generating the color translation table from the image data of the input image and the result of the color gamut mapping. Consequently, it is possible to generate the intended color profile easily for each image type without high expertise.

In the embodiment described above, the screen for configuring the color reproduction policy outside the color reproducible area is not displayed. This is because, in the photo image, colors reproducible by the output device 30 are frequently used, and colors outside the color reproducible area are not used often. However, some images include colors unreproducible by the output device 30, and that results in occurring issues such as collapsed gradation in some cases. Specifically, while color A and B are different originally, they are reproduced in the same color since color A is unreproducible, and that results in drawing an image without gradation. That issue is not noticeable if the ratio of the unreproducible colors is low in the image and they are reproduced using the same colors as neighboring colors. However, if the ratio of the unreproducible colors is high, the parts reproduced using the same colors become noticeable.

To cope with this issue, after evaluating colors of each pixel that consists of the input image, if the ratio of colors outside the reproducible area is larger than a predetermined value and the ratio is high, the color gamut mapping parameter outside the color reproducible area is determined. The color profile generator 14 can further include a color determination unit that evaluate colors of each pixel that consists of the input image and determine whether or not the ratio of colors reproducible by the output device 30 acquired from the characteristic data is larger than the predetermined value. The CPU can function as the color determination unit by executing a program.

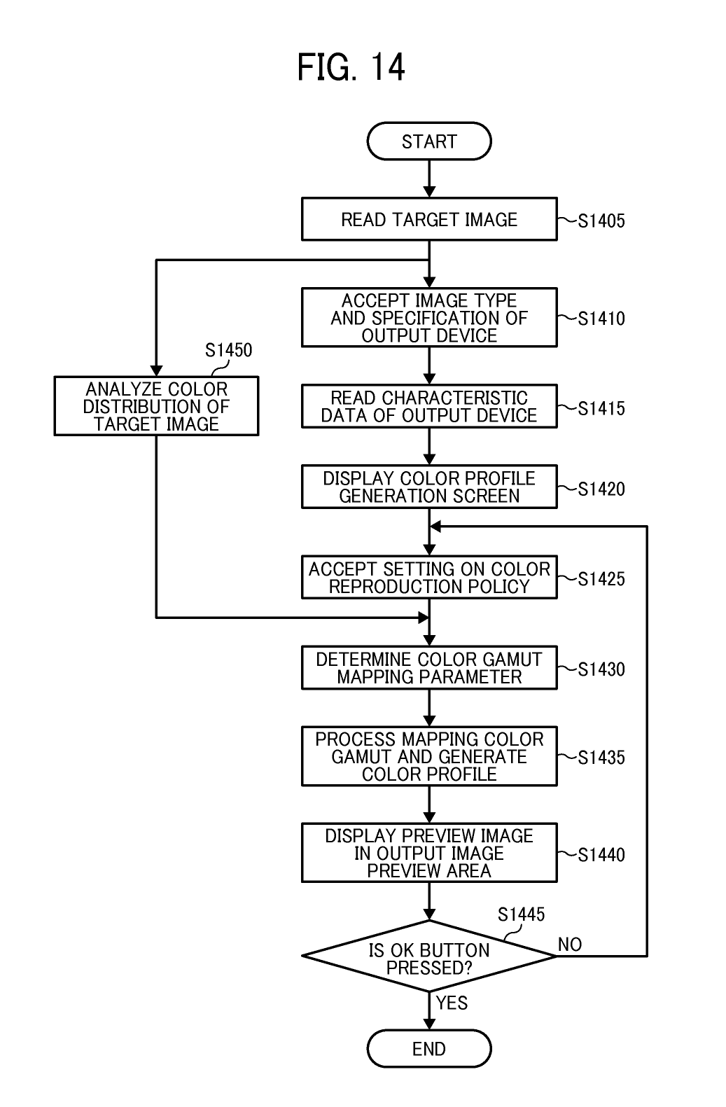

A process executed by the color profile generator 14 that includes the color determination unit is described with reference to FIG. 14. In FIG. 14, steps from S1405 to S1445 are the same as steps from S305 to S345 shown in FIG. 3. Therefore, description of those steps from S1405 to S1445 is omitted.

After finishing reading the input image in S1405, in parallel with accepting the image type and the specified output device 30 in 51410, color distribution of the input image is analyzed in S1450. Specifically, after detecting colors from all pixels that consist of the input image, it is determined whether or not the color is within the color reproducible area.

After performing the determination on all pixels, the ratio of pixels outside the color reproducible area in the input image is calculated by dividing the number of pixels determined as outside the color reproducible area by the number of all pixels that consist of the input image. Subsequently, after determining whether or not the ratio is larger than the predetermined value, the color gamut mapping parameter is determined based on the determination result. That is, if the ratio is larger than the predetermined value, the color distribution data is sent, and the compression parameter outside the color reproducible area is determined in accordance with the color distribution of the input image using the sent color distribution data in S1430. If the ratio is smaller than the predetermined value, data is not sent, and in S1430, the color gamut mapping parameter is determined by performing the same as in S330.

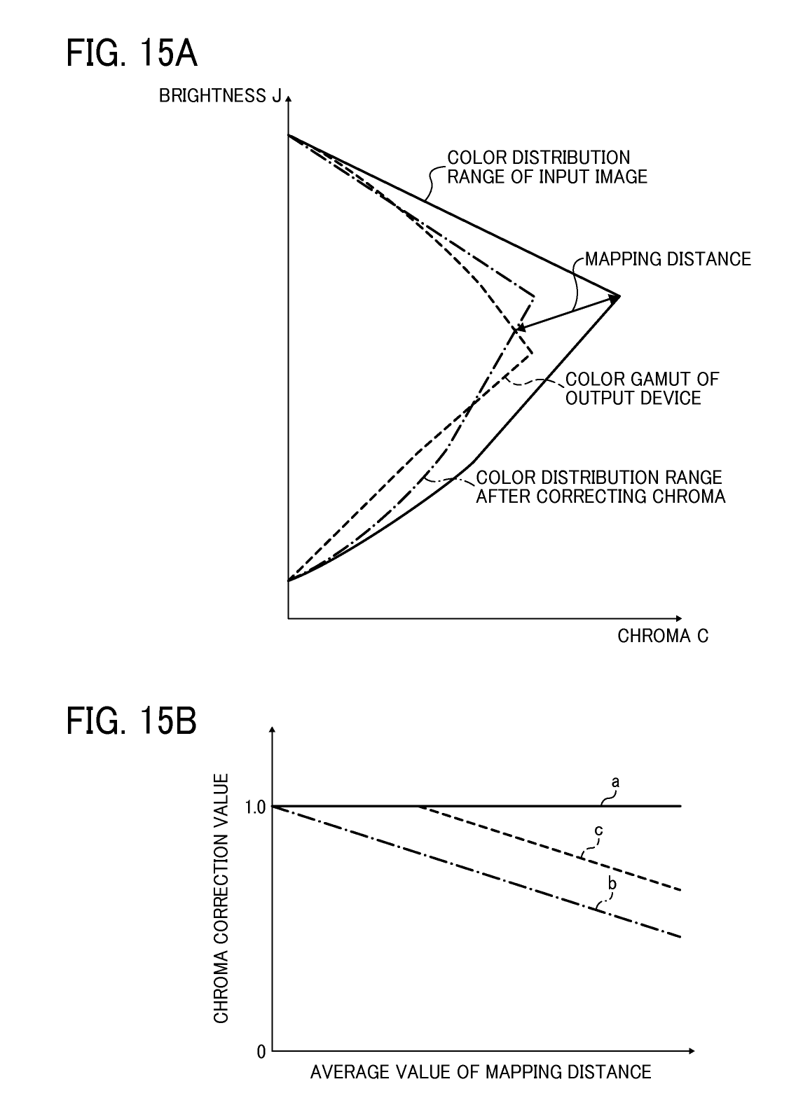

A method of determining the compression parameter outside the color reproducible area is described below in detail with reference to FIGS. 15A and 15B. FIG. 15A is a conceptual diagram illustrating a method of calculating chroma correction amount based on the color distribution, and FIG. 15B is a diagram illustrating relationship between the chroma correction value and mapping distance. As shown in FIG. 15A, the mapping distance indicates distance from each input color located outside the color gamut of the output device 30 to the color gamut of the output device 30.

The chroma correction value is determined based on statistic of the mapping distances. The statistic can be an average value, maximum value, or accumulation value. Since the color distribution range is indicated in three dimensions, the mapping distance can be calculated as coordinate distance between the point of input color signal and the color after mapping. This is just an example, and other method can be adopted.

The chroma correction value can be calculated from the statistic of the mapping distances with reference to the relationship shown in FIG. 15B. If the chroma correction value equals 1.0, that means that the chroma correction is not performed. In addition, if the chroma correction value equals 0, that means that chroma of all colors becomes 0.

In a solid line a in FIG. 15B, the chroma correction value equals 1.0 regardless of the mapping distances, and that means that the chroma correction is not performed. Consequently, all of input colors outside the color reproducible area of the output device 30 are mapped onto the surface of the color gamut of the output device 30, i.e., they are mapped onto the broken line in FIG. 15A. Therefore, some input colors outside the color reproducible area, even if those colors are different from each other, are mapped onto the same point on the broken line in FIG. 15A, and that result in collapsing gradation easily. Especially, the gradation collapse tends to occur in case the color gamut of the input image is broad.

In the broken line b in FIG. 15B, as the mapping distance gets long, the chroma correction value gets small. That means that, if colors outside the color reproduction area of the output device 30 are included in the input image, the chroma compression is performed in accordance with the color distribution. If the graph of the broken line b is adopted, since chroma is compressed overall, dynamic range of the image gets small, but gradation does not collapse. This is because different colors are compressed as different colors.

In the broken line c in FIG. 15B, the chroma correction value equals 1.0 until the mapping distance gets to a predetermined value, and the chroma correction value gets smaller beyond that. If the mapping distance is short, since the color gamut of the input image is not so broad, it is hard to collapse gradation, or gradation collapses very little even if the gradation collapse occurs. By contrast, if the mapping distance is long, since the color gamut of the input image is broad as described above, the gradation collapse occurs easily, and that affects the output image a lot. If the graph of the broken line c is adopted, it is possible to correct chroma in accordance with the mapping distance.

By adopting the configuration that includes the color determination unit and performing the chroma correction adopting the graph b or c described above, it is possible to realize intended color reproduction even on the image with broad color gamut and the ratio of pixels outside the color reproducible area is high.

In at least one of the above-described examples of the present invention, it is possible to customize the color profile in accordance with the image type and customize the color gamut mapping parameter using the intuitive parameters.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

What is claimed is:

1. A color profile generator that generates a color profile to translate colors, comprising:
a data reading unit to read image data of a specified image;
a specification acceptance unit to accept specifying an image type and an output device that outputs the image data;
a screen display unit to display a screen for inputting one or more setting values representing at least one index to be emphasized in performing color translation, the at least one index being associated with the specified image type;
a parameter determination unit to determine a parameter used for translating colors based on the one or more input setting values; and
a profile generator to translate colors of the specified image based on the determined parameter and characteristic data regarding colors of the specified output device, and generate the color profile using the read image data of the specified image and a result of translating colors.

2. The color profile generator according to claim 1, wherein the image type is one of a photo image, a graphic image, and a text and line image.

3. The color profile generator according to claim 1, wherein the screen display unit displays on the screen a part for inputting one or more setting values representing weight between gradation and image contrast as indexes if the specified image type is a photo image.

4. The color profile generator according to claim 3, wherein the parameter determination unit determines one of a chroma correction parameter for correcting chroma of color space of the specified image as an input image and a dynamic range correction parameter for correcting difference of dynamic range between the color space of the input image and color space reproducible by the output device acquired from the characteristic data as a parameter used for translating colors based on the setting value.

5. The color profile generator according to claim 1, wherein the screen display unit displays on the screen a part for inputting one or more setting values representing weight between gradation of the image and image color fidelity as indexes if the specified image type is a graphic image.

6. The color profile generator according to claim 5, wherein the parameter determination unit determines one of a hue correction amount for correcting a hue outside a color gamut reproducible by the output device acquired from the characteristic data among color gamuts of the specified image and a color gamut mapping direction for mapping the hue outside the color gamut onto a hue within color gamut reproducible by the output device as a parameter used for translating colors based on the setting value.

7. The color profile generator according to claim 1, wherein the screen display unit displays on the screen a part for inputting one or more setting values representing weight between color fidelity and identifiability as indexes if the specified image type is a text and line image.

8. The color profile generator according to claim 7, wherein the parameter determination unit determines one of a hue correction amount for correcting a hue outside a color gamut reproducible by the output device acquired from the characteristic data among color gamuts of the specified image and a color gamut mapping direction for mapping the hue outside the color gamut onto a hue within color gamut reproducible by the output device as a parameter used for translating colors based on the setting value.

9. The color profile generator according to claim 1, further comprising a color determination unit to extract colors of each pixel of which the specified image is composed and determine whether or not a ratio of color outside an area reproducible by the output device acquired from the characteristic data is larger than a predetermined value,
wherein the parameter determination unit determines a parameter used for translating colors based on the setting value and the determination made by the color determination unit.

10. An image processing apparatus, comprising:
the color profile generator according to claim 1;
a color translator to translate colors of an image using the color profile generated by the color profile generator; and
an image input/output apparatus to accept input of the image and output an image after translating colors to an output device.

11. An image processing system, comprising:
the image processing apparatus according to claim 10; and
an output device to accept input of the image after translating colors by the image processing apparatus and output the image.

12. A method of generating a color profile for translating colors, comprising the steps of:
reading image data of a specified image;
accepting specifying an image type and the output device that outputs the image data;
displaying a screen for inputting one or more setting values representing at least one index associated with the specified image type and emphasized in performing color translation;
determining a parameter used for translating colors based on the one or more input setting values; and
translating colors of the specified image based on the determined parameter and characteristic data regarding colors of the specified output device, and generating the color profile using the read image data and a result of translating colors.

13. The method of generating a color profile according to claim 12, further comprising the steps of:
extracting colors of each pixel of which the specified image is composed; and
determining whether or not a ratio of color outside an area reproducible by the output device acquired from the characteristic data is larger than a predetermined value,
wherein the determining step determines a parameter used for translating colors based on the setting value and the step of determining whether or not a ratio of color outside an area reproducible by the output device acquired from the characteristic data is larger than a predetermined value.

14. A computer-readable, non-transitory recording medium storing a program that, when executed by a computer, causes a processor to implement a method of generating a color profile for translating colors,
the method of generating a color profile for translating colors comprising the steps of:
reading image data of a specified image;
accepting specifying an image type and the output device that outputs the image data;
displaying a screen for inputting one or more setting values representing at least one index associated with the specified image type and emphasized in performing color translation;
determining a parameter used for translating colors based on the one or more input setting values; and
translating colors of the specified image based on the determined parameter and characteristic data regarding colors of the specified output device, and generating the color profile using the read image data and a result of translating colors.
